(19) United States
(12) Patent Application Publication
(10) Pub. No.: US 2026/0100672 A1
(43) Pub. Date: Apr. 9, 2026

(54) BEARING HOUSING ADAPTOR FOR SOLAR TRACKER

(71) Applicant: Nextracker LLC, Fremont, CA (US)

(72) Inventors: Raghavendra Praveen Maddulapalli, Vijayawada (IN); Abhimanyu Anil Sable, Hyderabad (IN)

(21) Appl. No.: 19/348,936

(22) Filed: Oct. 3, 2025

Related U.S. Application Data
(60) Provisional application No. 63/704,151, filed on Oct. 7, 2024.

(51) Int. Cl. H02S 20/32

(52) U.S. Cl. CPC H02S 20/32

(57) ABSTRACT

A solar tracker bearing housing assembly includes a bearing housing and a bearing housing adaptor. The bearing housing is configured to receive and support a torque tube at the bearing housing. The bearing housing adaptor is configured to couple the bearing housing to a solar tracker A-frame support. The bearing housing adaptor includes an frame coupling portion and an bearing housing coupling portion. The frame coupling portion is configured to couple the bearing housing adaptor to the solar tracker A-frame support. The frame coupling portion includes a frame coupling portion length that extends along the frame coupling portion where the frame coupling portion is configured to interface with and couple to the solar tracker A-frame support. The bearing housing coupling portion is configured to couple the bearing housing adaptor to the bearing housing.

### RELATED APPLICATIONS

This application claims priority to U.S. Provisional Ser. No. 63/704,151 filed on Oct. 7, 2024, the entire contents of which are incorporated herein by reference.

### TECHNICAL FIELD

This disclosure relates generally to device, system, and method embodiments for solar tracker bearing housing adaptors. Such solar tracker bearing housing adaptor embodiments disclosed herein can couple a bearing housing, which itself can receive and support a solar tracker torque tube, to a solar tracker support. Exemplary embodiments disclosed herein describe solar tracker bearing housing adaptor embodiments that can couple a bearing housing to one or more legs of a tubular support member, such as a solar tracker A-frame support.

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Typical solar tracker systems installed in the field support the solar modules at the ground surface using a bearing at a foundation component which is embedded at the ground surface. However, such typical solar tracker systems can involve a significant number of components, material, and inter-component connections to ultimately install the solar tracker system at the bearing and foundation, and, thus, can increase the cost associated with installing a solar tracker system and/or the cost associated with maintaining operation of a solar tracker system.

### SUMMARY

This disclosure in general describes embodiments relating to solar tracker bearing housing adaptors. Such solar tracker bearing housing adaptor embodiments disclosed herein can couple a bearing housing, which itself can receive and support a solar tracker torque tube, to a solar tracker support. For instance, exemplary embodiments disclosed herein describe solar tracker bearing housing adaptor embodiments that can couple a bearing housing to one or more legs of a solar tracker A-frame support. In this way, solar tracker bearing housing adaptor embodiments disclosed herein can act to transfer one or more load(s) from a torque tube of a solar tracker, which can be imparted on the bearing housing adaptor(s) via the bearing housing, to the solar tracker support embedded in the ground (e.g., to a pair of legs of a solar tracker A-frame support embedded in the ground).

Such embodiments disclosed herein can be useful in reducing the material, size, weight, and/or cost associated with coupling a solar tracker bearing housing to a solar tracker ground support. For example, bearing housing adaptor embodiments disclosed herein can reduce weight and size, for instance, by reducing the amount of material used for the bearing housing adaptor and, thereby, reduce cost associated with bearing housing adaptor components. Yet, in addition to such useful cost reduction, bearing housing adaptor embodiments disclosed herein can provide a structurally robust load transfer mechanism between a bearing housing and solar tracker support (e.g., A-frame support). Thus, bearing housing adaptor embodiments disclosed herein can synergistically reduce cost and complexity associated with solar trackers (e.g., installation and operational maintenance) while functionally transferring loading between a torque tube, via the bearing housing, and a ground embedded support.

One embodiment includes a solar tracker bearing housing assembly. This solar tracker bearing housing assembly includes a bearing housing and a bearing housing adaptor. The bearing housing is configured to receive and support a torque tube at the bearing housing. The bearing housing adaptor is configured to couple the bearing housing to a solar tracker A-frame support. The bearing housing adaptor includes an frame coupling portion and an bearing housing coupling portion. The frame coupling portion is configured to couple the bearing housing adaptor to the solar tracker A-frame support. The frame coupling portion includes a frame coupling portion length that extends along the frame coupling portion where the frame coupling portion is configured to interface with and couple to the solar tracker A-frame support. The bearing housing coupling portion is configured to couple the bearing housing adaptor to the bearing housing. The bearing housing coupling portion includes an bearing housing coupling portion length in a direction parallel to the frame coupling portion length. The bearing housing coupling portion length is less than the frame coupling portion length, and the bearing housing coupling portion length narrows in a direction away from the frame coupling portion.

In a further embodiment of this assembly, the bearing housing coupling portion includes a first bearing housing coupling portion face that is configured to interface with the bearing housing and a second bearing housing coupling portion face that is opposite the first bearing housing coupling portion face, and the first bearing housing coupling portion face is oriented non-parallel to the second bearing housing coupling portion face. For some such embodiments, the first bearing housing coupling portion face can define a first planar surface, and the second bearing housing coupling portion face can define a second planar surface, where the second planar surface is skewed relative to the first planar surface. For example, the first bearing housing coupling portion face can include one or more coupling apertures configured to receive at least one fastener to couple the bearing housing coupling portion to the bearing housing. As one specific such example, the one or more coupling apertures can include a plurality of coupling apertures each defined at the first bearing housing coupling portion face. In additional or alternative examples, the first bearing housing coupling portion face and the second bearing housing coupling portion face can intersect to form a triangular cross-sectional apex at an end of the bearing housing coupling portion that is opposite the frame coupling portion, and the frame coupling portion length can form the base of a triangular cross-section having the triangular cross-sectional apex. In some such examples, the bearing housing coupling portion length can be defined between the first bearing housing coupling portion face and the second bearing housing coupling portion face. For instance, the bearing housing coupling portion length can narrow moving in a direction away from the frame coupling portion by continuously tapering in the direction away from the frame coupling portion.

For some such embodiments, the frame coupling portion can include a first frame coupling portion face extending from the first bearing housing coupling portion face at a non-parallel orientation relative to the first bearing housing coupling portion face, and the frame coupling portion can include a second frame coupling portion face extending from the second bearing housing coupling portion face at a parallel orientation relative to the second bearing housing coupling portion face. The frame coupling portion length can extend between the first frame coupling portion face and the second frame coupling portion face. In some such examples, the first frame coupling portion face extends from the first bearing housing coupling portion face at angle between ninety and one hundred and eighty degrees. For instance, the frame coupling portion can include a first frame coupling aperture adjacent to the first frame coupling portion face, and the frame coupling portion can include a second frame coupling aperture adjacent to the second frame coupling portion face. In one example, the first frame coupling portion face can begin to project outward from the first bearing housing coupling portion face at a location aligned with the first frame coupling aperture.

Another embodiment includes a system of bearing housing adaptors configured to couple a bearing housing to a solar tracker A-frame support. This system embodiment of bearing housing adaptors can include a first bearing housing adapter and a second bearing housing adapter. The first bearing housing adaptor can include a first frame coupling portion and a first bearing housing coupling portion. The first frame coupling portion can be configured to couple the first bearing housing adaptor to the solar tracker A-frame support. The first frame coupling portion can include a first frame coupling portion length that extends along the first frame coupling portion where the first frame coupling portion is configured to interface with and couple to the solar tracker A-frame support. The first bearing housing coupling portion can be configured to couple the first bearing housing adaptor to the bearing housing. The first bearing housing coupling portion can include a first bearing housing coupling portion length in a direction parallel to the first frame coupling portion length. The first bearing housing coupling portion length can be less than the first frame coupling portion length, and the first bearing housing coupling portion length can narrow in a direction away from the first frame coupling portion. The second bearing housing adaptor can include a second frame coupling portion and a second bearing housing coupling portion. The second frame coupling portion can be configured to couple the second bearing housing adaptor to the solar tracker A-frame support. The second frame coupling portion can include a second frame coupling portion length that extends along the second frame coupling portion where the second frame coupling portion is configured to interface with and couple to the solar tracker A-frame support. The second bearing housing coupling portion can be configured to couple the second bearing housing adaptor to the bearing housing. The second bearing housing coupling portion can include a second bearing housing coupling portion length in a direction parallel to the second frame coupling portion length. The second bearing housing coupling portion length can be less than the second frame coupling portion length, and the second bearing housing coupling portion length can narrow in a direction away from the second frame coupling portion.

In a further embodiment of this system, the first bearing housing coupling portion can be configured to couple the first bearing housing adaptor to a first side of the bearing housing, and the second bearing housing coupling portion can be configured to couple the second bearing housing adaptor to a second, opposite side of the bearing housing. For example, the first frame coupling portion can include a first frame coupling aperture, and the second frame coupling portion can include a second frame coupling aperture. The first frame coupling aperture of the first frame coupling portion can be configured to overlap with the second frame coupling aperture of the second frame coupling portion at the solar tracker A-frame support such that a fastener can be received through each of the first frame coupling aperture of the first frame coupling portion and the second frame coupling aperture of the second frame coupling portion at the A-frame support.

In a further embodiment of this system, the first bearing housing adaptor can be geometrically identical to the second bearing housing adaptor.

Another embodiment includes a bearing housing adaptor configured to couple a bearing housing to a solar tracker A-frame support. This bearing housing adaptor embodiment includes a frame coupling portion and a bearing housing coupling portion. The frame coupling portion is configured to couple the bearing housing adaptor to the solar tracker A-frame support, and the bearing housing coupling portion can be configured to couple the bearing housing adaptor to the bearing housing. The bearing housing coupling portion can be a right angle bearing housing coupling portion that defines a cross-sectional geometry that includes a right angle adjacent to the first frame coupling portion.

In a further embodiment of this adaptor, the frame coupling portion includes a frame coupling portion length that extends along the frame coupling portion where the frame coupling portion is configured to interface with and couple to the solar tracker A-frame support. And the bearing housing coupling portion can include a bearing housing coupling portion length in a direction parallel to the frame coupling portion length. The bearing housing coupling portion length can be less than the frame coupling portion length, and the bearing housing coupling portion length can narrow in a direction away from the frame coupling portion.

In a further embodiment of this adaptor, the bearing housing coupling portion includes a first bearing housing coupling portion face configured to interface with the bearing housing and includes a second bearing housing coupling portion face that is opposite the first bearing housing coupling portion face. The first bearing housing coupling portion face can be oriented non-parallel to the second bearing housing coupling portion face. The first bearing housing coupling portion face can define a first planar surface, and the first bearing housing coupling portion can include a plurality of coupling apertures each defined at the first planar surface of the first bearing housing coupling portion face. The second bearing housing coupling portion face can define a second planar surface, and the second planar surface can be skewed relative to the first planar surface.

In a further embodiment of this adaptor, the frame coupling portion can include a first frame coupling portion face that extends from the first bearing housing coupling portion face at a non-parallel orientation relative to the first bearing housing coupling portion face. The frame coupling portion can additionally include a second frame coupling portion face that extends from the second bearing housing coupling portion face at a parallel orientation relative to the second bearing housing coupling portion face. The frame coupling portion length can extend between the first frame coupling portion face and the second frame coupling portion face. For some such embodiments, the first frame coupling portion face can extend from the first bearing housing coupling portion face at angle between ninety and one hundred and eighty degrees, the frame coupling portion can include a first frame coupling aperture adjacent to the first frame coupling portion face, and/or the frame coupling portion can include a second frame coupling aperture adjacent to the second frame coupling portion face.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is an elevational view diagram of an exemplary embodiment of a solar tracker system.

FIG. 2 is an elevational view of an exemplary embodiment of a solar tracker bearing housing assembly coupled to a tubular support member which is illustrated for this example as an A-frame support.

FIGS. 3A-3C illustrate an exemplary embodiment of a bearing housing adaptor as shown for the solar tracker bearing housing assembly of FIG. 2. FIG. 3A is a perspective view of the embodiment of the bearing housing adaptor, FIG. 3B is one side elevational view of the bearing housing adaptor of FIG. 3A, and FIG. 3C is another side elevational view of the bearing housing adaptor of FIG. 3A offset approximately ninety degrees relative to the side elevational view shown at FIG. 3B.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to relating to bearing housing adapters for coupling a bearing housing to a solar tracker tubular support member, such as a solar tracker A-frame support that can be partially embedded in the underlying ground. For instance, certain such embodiments disclosed herein include a bearing housing adaptor configured to couple a bearing housing to a solar tracker A-frame support, with this bearing housing adaptor including both a frame coupling portion (sometimes referred to as an adapter frame coupling portion) and a second coupling portion, such as a bearing housing coupling portion (sometimes referred to as an adaptor bearing housing coupling portion). The adaptor frame coupling portion can be configured to couple the bearing housing adaptor to the solar tracker A-frame support, and the adaptor frame coupling portion can include an adaptor frame coupling portion length that extends along the adaptor frame coupling portion where the adaptor frame coupling portion is configured to interface with and couple to the solar tracker A-frame support. The bearing housing coupling portion can be configured to couple the bearing housing adaptor to the bearing housing. The bearing housing coupling portion can include a bearing housing coupling portion length in a direction parallel to the adaptor frame coupling portion length, and this bearing housing coupling portion length can both be less than the adaptor frame coupling portion length and narrow in a direction away from the adaptor frame coupling portion. Such embodiments disclosed herein can be useful in reducing the material, size, weight, and/or cost associated with coupling a solar tracker bearing housing to a solar tracker ground support. For example, bearing housing adaptor embodiments disclosed herein can reduce weight and size, for instance, by reducing the amount of material used for the bearing housing adaptor and, thereby, reduce cost associated with bearing housing adaptor components. Yet, in addition to such useful cost reduction, bearing housing adaptor embodiments disclosed herein can provide a structurally robust load transfer mechanism between a bearing housing and solar tracker tubular support member (e.g., A-frame support).

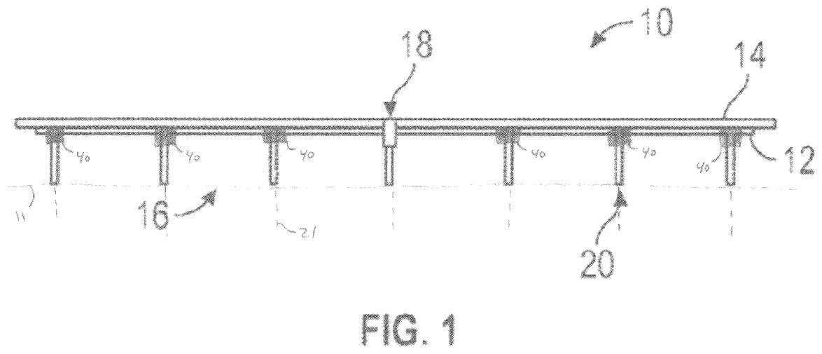

FIG. 1 is an elevational view diagram of an exemplary embodiment of a solar tracker system 10. FIG. 1 shows the system 10 at a side elevational view looking in an east-west orientation at the system 10. In some applications, a plurality of solar trackers 10 may be arranged in a north-south longitudinal orientation to form rows of a solar array. The solar tracker system 10 includes a plurality of tubular support members 20 disposed in spaced relation to one another and partially embedded in the earth. As illustrated at other figures, one or more of the tubular support members 20 can, for example, be a solar tracker A-frame support with multiple (e.g., two) legs each partially embedded in the underlying ground 11. A torque tube 12 extends between each adjacent support member 20 and is rotatably supported at each support member 20. The solar tracker 10 includes a plurality of solar modules, or panels, 14 supported on each respective torque tube 12. The span between two adjacent support members 20 is referred to as a bay 16 and may be generally in the range of about 8 meters in length. The solar tracker support member 20 can be supported at a ground surface 11 via one or more foundation components 21 (e.g., subterranean pile). For instance, where the solar tracker support member 20 is an A-frame support, the A-frame support can include a pair of legs with each such leg of the pair supported at the ground 11 via subterranean pile 21. The foundation components (e.g., subterranean piles) 21 can extend into and below ground surface 11 so as to be embedded into the ground surface 11 to support the above-ground, respective solar tracker support frame leg(s) and associated respective bearing housings 40. The foundation components 21 can, for example, one or more blade piles (e.g., a pair of blade piles), one or more screw piles (e.g., a pair of screw piles), and/or one or more concrete footings (e.g., a pair of concrete footings) as examples.

The solar tracker 10 includes at least one motive source (e.g., drive motor, slew drive, etc.) 18 operably coupled to the torque tube 12 and supported at a tubular support member 20. The motive source 18 effectuates rotation of the torque tube 12, which effectuates a corresponding rotation of the solar panels 14 to track the location of the sun. The solar tracker system 10 includes a plurality of bearing housings 40 coupled to support members 20. Each bearing housing 40 can receive and rotatably support the torque tube 12 thereat. Thus, each of the bearing housings 40 can receive and be operably coupled to the torque tube 12 to rotatably support the torque tube 12 therein as the torque tube 12 is caused to be rotated by the motive source.

Installing a typical solar tracker system in the field can oftentimes necessitate installation of a significant number of components, including effectuating the interconnections between the significant number of components ranging from subterranean foundation components and connections to above-ground bearing connections and solar module support connections. This can act to increase the cost associated with generating solar energy. Embodiments disclosed herein and described as follows can provide a bearing housing adaptor that is configured to couple a bearing housing to a tubular support member, such as an A-frame support, of a solar tracker system. Such bearing housing adaptor embodiments disclosed as follows can help to reduce the cost of a solar tracker system while providing a structurally stable bearing assembly (e.g., rotatable torque tube bearing assembly) at a tubular support member (e.g., an a A-frame support). Such bearing housing adaptor embodiments disclosed as follows can do so by, for instance, reducing the material, size, and/or weight associated with coupling a solar tracker bearing housing to a solar tracker ground support, such as an A-frame. Such bearing housing adaptor embodiments disclosed as follows can eliminate material requirements associated with coupling a solar tracker bearing housing to a solar tracker ground support yet can do so without detrimentally impacting structural stability in coupling the solar tracker bearing housing to the solar tracker ground support.

When applied to solar tracker applications, the bearing housing adaptor embodiments disclosed herein can be used with a variety of solar tracker supports to couple the bearing housing (e.g., and, thus, the torque tube) to the solar tracker support. For example, the bearing housing adaptor embodiments disclosed herein can be coupled to a multi-leg solar tracker support frame, such as an A-frame, which multi-legs are embedded in the ground surface (e.g., via a respective pair of subterranean piles).

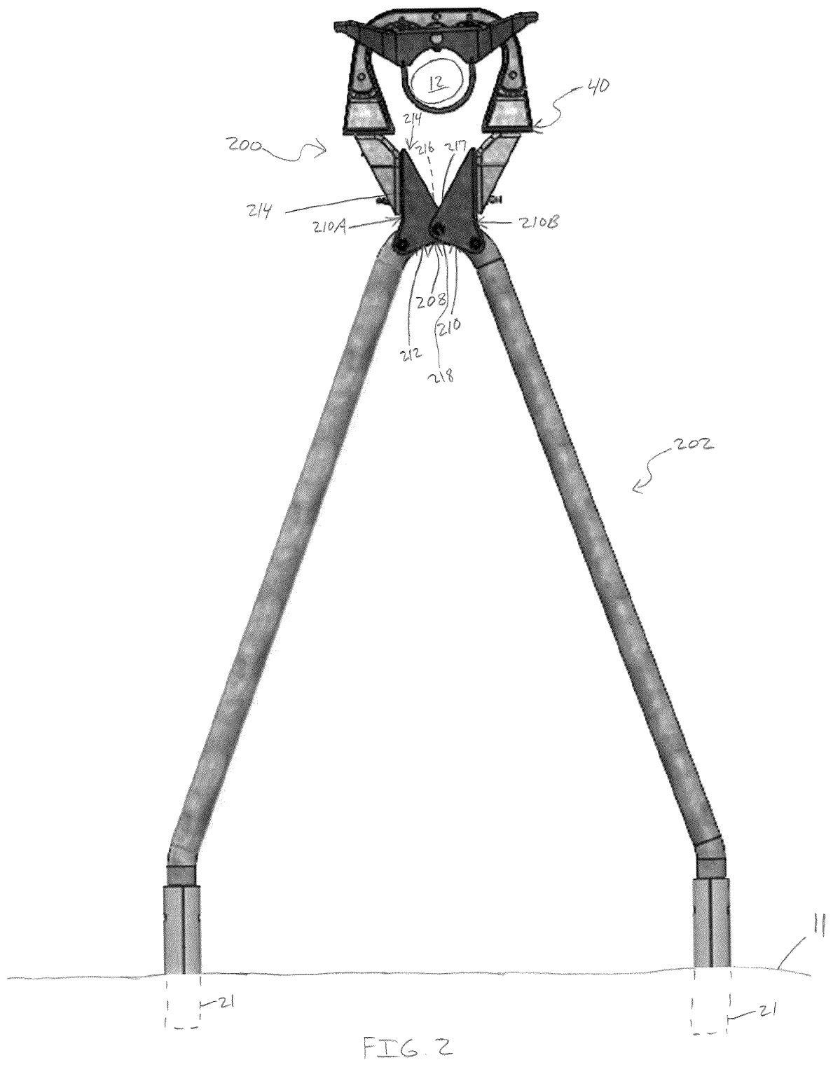

FIG. 2 illustrates an elevational view of an exemplary embodiment of a solar tracker bearing housing assembly 200 coupled to an A-frame support 202. The bearing housing assembly 200 can include bearing housing 40 and bearing housing adaptor system 208. The bearing housing 40 can be configured to receive and support torque tube 12 at the bearing housing 40. In particular, the bearing housing 40 can rotatable support the torque tube 12 thereat such that the torque tube 12 can rotate relative to the bearing housing 40, for instance, to change an angle of incidence of one or more solar modules at the rotatable torque tube 12. The bearing housing adaptor system 208 can couple the bearing housing 40 to the A-frame support 202. Thus, the bearing housing adaptor system 208 can act to couple the rotatable torque tube 12 to the A-frame support 202 by coupling the bearing housing 40 to the A-frame support 202.

The bearing housing adaptor system 208, shown at the example of FIG. 2, includes a pair of bearing housing adaptors 210—first bearing housing adaptor 210A and second bearing housing adaptor 210B. The illustrated embodiment shows that the first bearing housing adaptor 210A and second bearing housing adaptor 210B can be geometrically identical, and the illustrated embodiment shows that the first bearing housing adaptor 210A and second bearing housing adaptor 210B can be coupled between the bearing housing 40 and the A-frame support 202 at inverse, or mirror-image, orientations relative to one another. For such embodiments where the first bearing housing adaptor 210A and second bearing housing adaptor 210B are geometrically identical, this can act to increase manufacturing efficiency and inventor efficiency thereby helping to reduce cost.

Each of the first bearing housing adaptor 210A and second bearing housing adaptor 210B can be configured to couple the bearing housing 40 to the A-frame support 202. Each of the first bearing housing adaptor 210A and second bearing housing adaptor 210B can include an adaptor frame coupling portion 212 and a second coupling portion (e.g., which can be a bearing housing coupling portion) 214. The adaptor frame coupling portion 212 can be configured to couple the respective bearing housing adaptor 210 to the A-frame support 202. The adaptor bearing housing coupling portion 214 can be configured to couple the respective bearing housing adaptor 210 to the bearing housing 40.

The adaptor bearing housing coupling portion 214 of the first bearing housing adaptor 210A can be configured to couple the first bearing housing adaptor 210A to a first side of the bearing housing 40, and the adaptor bearing housing coupling portion of the second bearing housing adaptor 210B can be configured to couple the second bearing housing adaptor 210B to a second, opposite side of the bearing housing 40. For instance, as shown here, the adaptor bearing housing coupling portion 214 of each of the first and second bearing housing adaptor 210A, 210B can be configured to couple the respective first and second bearing housing adaptor 210A, 210B along a vertically aligned coupling interface 214.

As also shown at the example at FIG. 2, the first and second bearing housing adaptors 210A, 210B can be coupled to the A-frame support 202 in at least a partially overlapping manner. In particular, the adaptor frame coupling portion 212 of the first bearing housing adaptor 210A can include a first frame coupling aperture 216 and the adaptor frame coupling portion 212 of the second bearing housing adaptor 210B can include a second frame coupling aperture 217. The first frame coupling aperture 216 of the adaptor frame coupling portion 212 of the first bearing housing adaptor 210A can be configured to overlap with the second frame coupling aperture 217 of the adaptor frame coupling portion 212 of the second bearing housing adaptor 210B at the solar tracker A-frame support 202 such that a common fastener 218 can be received through each of the first frame coupling aperture 216 and the second frame coupling aperture 217 and at the A-frame support 202. Thus, the first and second bearing housing adapters 210A, 210B can be configured to couple to the A-frame support along their respective, at least partially overlapping adaptor frame coupling portions 212.

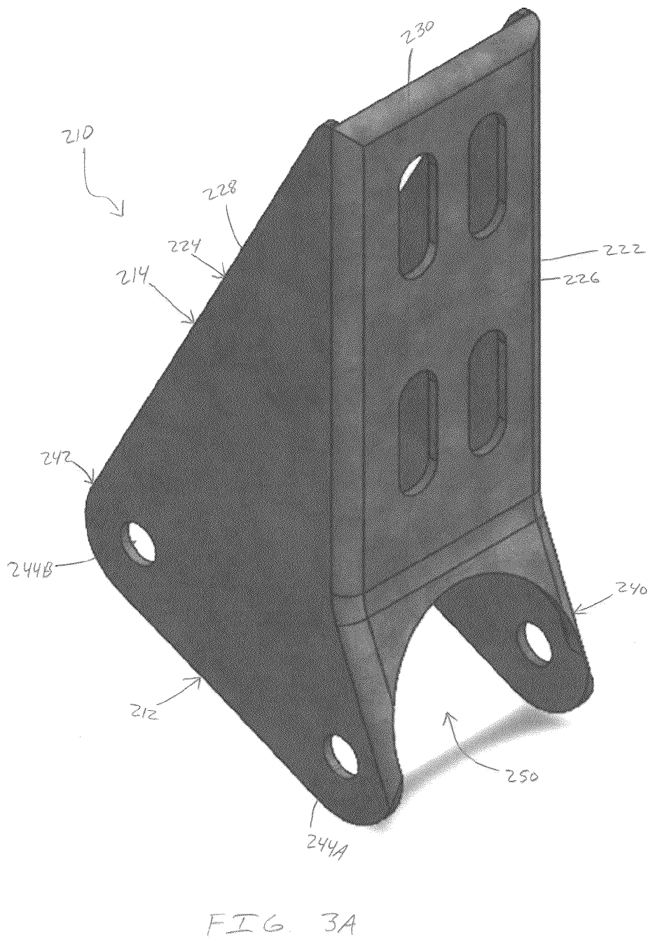

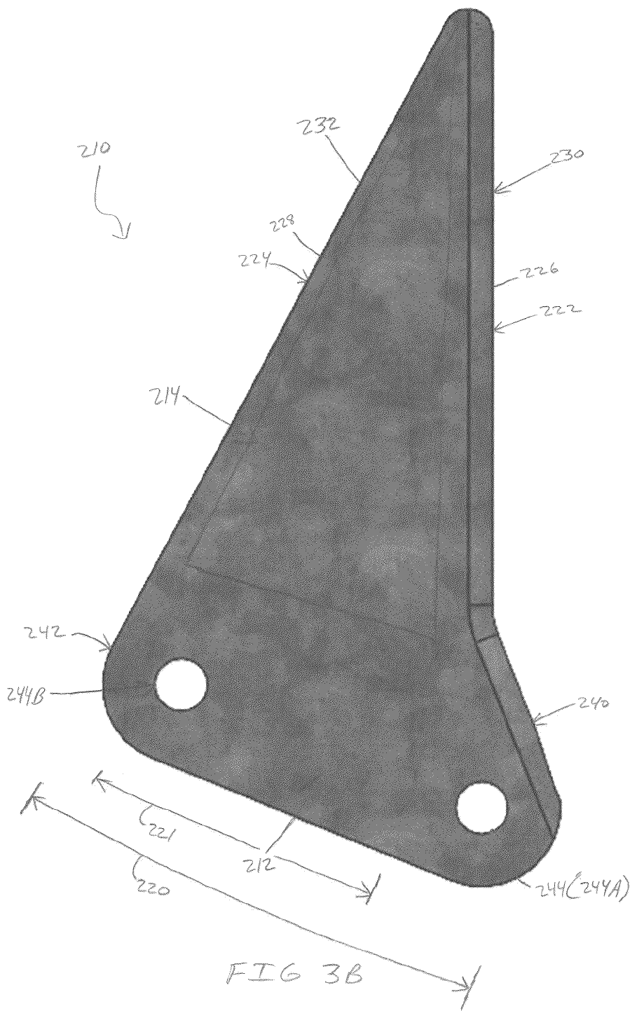

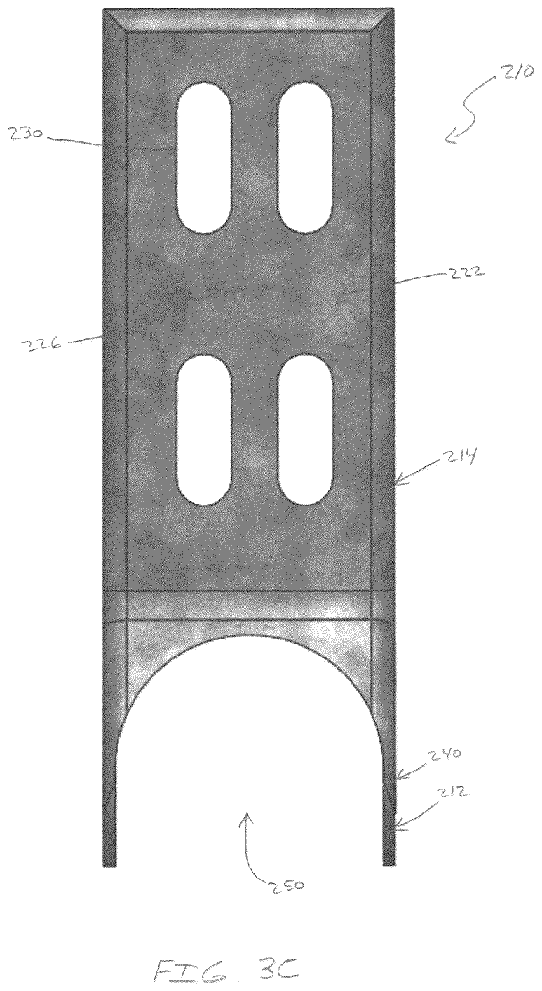

FIGS. 3A-3C illustrate in isolation the embodiment of the bearing housing adaptor 210 of FIG. 2. Specifically, FIG. 3A is a perspective view of this bearing housing adaptor 210, FIG. 3B is one side elevational view of this bearing housing adaptor 210, and FIG. 3C is another side elevational view of this bearing housing adaptor 210 offset approximately ninety degrees relative to the side elevational view shown at FIG. 3B.

As described previously in reference to FIG. 2, the bearing housing adaptor 210 can include the adaptor frame coupling portion 212 and the adaptor bearing housing coupling portion 214. The adaptor frame coupling portion 212 can be configured to couple the bearing housing adaptor 210 to the solar tracker A-frame support. The adaptor frame coupling portion 212 can include an adaptor frame coupling portion length 220 that extends along the adaptor frame coupling portion 212 where the adaptor frame coupling portion 212 is configured to interface with and couple to the solar tracker A-frame support. The adaptor bearing housing coupling portion 214 can be configured to couple the bearing housing adaptor 210 to the bearing housing. The adaptor bearing housing coupling portion 214 can include an adaptor bearing housing coupling portion length 221 in a direction parallel to the adaptor frame coupling portion length 220. As shown at FIG. 3B specifically, the adaptor bearing housing coupling portion length 221 can be less than the adaptor frame coupling portion length 220. And as also shown at FIG. 3B, the adaptor bearing housing coupling portion length 221 can narrow in a direction away from the adaptor frame coupling portion 212. For example, the adaptor bearing housing coupling portion length 221 can narrow in a direction away from the adaptor frame coupling portion 212 by continuously tapering in the direction away from the adaptor frame coupling portion 212.

The adaptor bearing housing coupling portion 214 can include a first adaptor bearing housing coupling portion face 222 and a second adaptor bearing housing coupling portion face 224. The first adaptor bearing housing coupling portion face 222 can be configured to interface with the bearing housing, such as illustrated at FIG. 2, and the second adaptor bearing housing coupling portion face 224 can be opposite the first adaptor bearing housing coupling portion face 222. The first adaptor bearing housing coupling portion face 222 can be oriented non-parallel to the second adaptor bearing housing coupling portion face 224. For instance, the second adaptor bearing housing coupling portion face 224 can be skewed relative to the first adaptor bearing housing coupling portion face 222. The first adaptor bearing housing coupling portion face 222 can define a first planar surface 226, and the second adaptor bearing housing coupling portion face 224 can define a second planar surface 228. For some embodiments of the bearing housing adaptor 210, such as that illustrated here, the second planar surface 228 can be skewed relative to the first planar surface 226, for instance, such that an angle between the first and second planar surface 226, 228 (e.g., at an apex of the adaptor bearing housing coupling portion 214) can range between zero and ninety degrees (e.g., can range between thirty and eighty degrees).

The first adaptor bearing housing coupling portion face 222 and the second adaptor bearing housing coupling portion face 224 can intersect at an apex of the bearing housing adapter 210 to form a triangular cross-sectional shape 232. In some embodiments, such as that illustrated, the bearing housing coupling portion 214 can define a right angle bearing housing coupling portion 214. For instance, such a right angle bearing housing coupling portion 214 can define a cross-sectional geometry at a side face of the bearing housing coupling portion 214 (e.g., a side face extending between the first and second planar surfaces 226, 228) that includes a right angle at such cross-sectional geometry at a side face of the bearing housing coupling portion 214. For instance, triangular cross-sectional shape 232 can include a right angle adjacent to the frame coupling portion 212 (e.g., such as adjacent to second frame coupling aperture 244B at frame coupling portion 212). The apex of the bearing housing adapter 210, and thus an apex of the triangular cross-sectional shape 232, can be at an end of the adaptor bearing housing coupling portion 214 that is opposite the adaptor frame coupling portion 212. And the adaptor frame coupling portion length 220 or the adaptor bearing housing coupling portion length 221 can form the base of a triangular cross-sectional shape 232 having the triangular cross-sectional apex opposite the base adaptor frame coupling portion length 220 or the adaptor bearing housing coupling portion length 221.

For some embodiments, the adaptor bearing housing coupling portion length 221 can be defined between the first adaptor bearing housing coupling portion face 222 and the second adaptor bearing housing coupling portion face 224. This adaptor bearing housing coupling portion length 221 can narrow moving in a direction away from the adaptor frame coupling portion 212, for instance, by continuously tapering in the direction away from the adaptor frame coupling portion 212. Thus, the apex of the triangular cross-sectional shape 232 can be at a narrower portion of the adaptor bearing housing coupling portion length 221 than the base of the triangular cross-sectional shape 232 is defined by the adaptor bearing housing coupling portion length 221.

The first adaptor bearing housing coupling portion face 222 can include one or more coupling apertures 230. Such one or more coupling apertures 230 can be configured to receive at least one fastener to couple the adaptor bearing housing coupling portion 214 of the bearing housing adaptor 210 to the bearing housing, for instance at a vertically oriented coupling interface, such as shown at FIG. 2. The illustrated embodiment shows that the one or more coupling apertures 230 can be a plurality of coupling apertures 230 each defined at the first adaptor bearing housing coupling portion face 222. While only one fastener and one coupling aperture 230 may be used at the first adaptor bearing housing coupling portion face 222 to couple the bearing housing adaptor 210 to the bearing housing, the presence of multiple coupling apertures 230 at the first adaptor bearing housing coupling portion face 222 can be useful in providing component-to-component alignment tolerances during solar tracker system assembly and installation.

Like the adaptor bearing housing coupling portion 214, the adaptor frame coupling portion 212 can have multiple faces. In particular, the adaptor frame coupling portion 212 can include a first adaptor frame coupling portion face 240 and a second adaptor frame coupling portion face 242. The first adaptor frame coupling portion face 240 can extend outward from the first adaptor bearing housing coupling portion face 222 at a non-parallel orientation relative to the first adaptor bearing housing coupling portion face 222. For instance, the first adaptor frame coupling portion face 240 can extend from the first adaptor bearing housing coupling portion face 222 at an angle between ninety and one hundred and eighty degrees, such as between one hundred and twenty degrees and one hundred and seventy degrees relative to the first adaptor bearing housing coupling portion face 222. The second adaptor frame coupling portion face 242 can extend from the second adaptor bearing housing coupling portion face 224 at a parallel orientation relative to the second adaptor bearing housing coupling portion face 224 (e.g., such as that the second adaptor frame coupling portion face 242 and the second adaptor bearing housing coupling portion face 224 can be co-incident, parallel, and co-planar). The adaptor frame coupling portion length 220 can extend between the first adaptor frame coupling portion face 240 and the second adaptor frame coupling portion face 242.

The adaptor frame coupling portion 212 can include one or more frame coupling apertures 244. For example, the illustrated embodiment of the bearing housing adaptor 210 can have the adaptor frame coupling portion 212 as including a first frame coupling aperture 244A that is adjacent to the first adaptor frame coupling portion face 240 and a second frame coupling aperture 244B that is adjacent to the second adaptor frame coupling portion face 242. The frame coupling apertures 244 at the adaptor frame coupling portion 212 can be included as pairs with one frame coupling aperture 244 at one side of the adaptor frame coupling potion 212 and the other frame coupling aperture 244 of the pair at the other, opposite side of the adaptor frame coupling portion 212 such that when the adaptor frame coupling portion 212 is positioned to interface with a bridge of the A-frame (e.g., as shown at FIG. 2), the pair of frame coupling apertures 244 at opposite sides of the adaptor frame coupling potion 212 can be axially aligned with one another at opposite sides of the bridge of the A-frame such that a common fastener can be used through the aligned pair of frame coupling apertures 244 at opposite sides of the adaptor frame coupling potion 212 and through the bridge of the A-frame. As shown best at the example of FIG. 3B, for some embodiments, the first adaptor frame coupling portion face 240 can begin to project outward from the first adaptor bearing housing coupling portion face 222 at a location that is axially aligned with the first frame coupling aperture 244A. As also shown at the example at FIG. 3B, the pair of frame coupling apertures 244A, 244B can be axially aligned and both be at the adaptor frame coupling portion 212, such as the pair of frame coupling apertures 244A, 244B both being axially aligned at the adaptor frame coupling portion 212 and below where the first adaptor frame coupling portion face 240 begins to diverge, and extend outward, from the first adaptor bearing housing coupling portion face 222.

As described herein, the adaptor frame coupling potion 212 of the bearing housing adaptor 210 can be configured to receive and couple to the A-frame support, such as at a bridge of the A-frame support (e.g., as shown at the example of FIG. 2). To accommodate coupling the adaptor frame coupling potion 212 to the A-frame support, the adaptor frame coupling potion 212 can define a support receptacle 250. The adaptor frame coupling potion 212 can define the support receptacle 250 through a bottom end side of the adaptor frame coupling potion 212 (e.g., through a bottom end side of the adaptor frame coupling potion 212 adjacent to the base of the triangular cross-sectional shape 232). Because the first adaptor frame coupling portion face 240 of the adaptor frame coupling potion 212 can extend outward from the first adaptor bearing housing coupling portion face 222 of the adaptor bearing housing coupling portion 214 (e.g., at a non-parallel orientation relative to the first adaptor bearing housing coupling portion face 222), the support receptacle 250 can begin at a side of the bearing housing adaptor 210 prior to where the first adaptor bearing housing coupling portion face 222 is located.

Various examples have been described. These and other examples are within the scope of the following claims.

What is claimed is:

1. A solar tracker bearing housing assembly comprising:
a bearing housing configured to support a torque tube of a solar tracker; and
a bearing housing adaptor configured to couple the bearing housing to a tubular support member, the bearing housing adaptor comprising:
a frame coupling portion that is configured to couple the bearing housing adaptor to the tubular support member, the frame coupling portion comprising a first coupling portion configured to interface with and couple to the tubular support member, and
a bearing housing coupling portion that is configured to couple the bearing housing adaptor to the bearing housing.

2. The assembly of claim 1,
wherein the first coupling portion comprises a first coupling portion length that extends along the frame coupling portion where the frame coupling portion is configured to interface with and couple to the tubular support member,
wherein the bearing housing coupling portion comprises a bearing housing coupling portion length in a direction parallel to the first coupling portion length, the bearing housing coupling portion length being less than the frame coupling portion length, and the bearing housing coupling portion length narrowing in a direction away from the frame coupling portion,
wherein the bearing housing coupling portion comprises a first bearing housing coupling portion face configured to interface with the bearing housing,
wherein the bearing housing coupling portion comprises a second bearing housing coupling portion face that is opposite the first bearing housing coupling portion face, and
wherein the first bearing housing coupling portion face is oriented non-parallel to the second bearing housing coupling portion face.

3. The assembly of claim 2,
wherein the first bearing housing coupling portion face defines a first planar surface,
wherein the second bearing housing coupling portion face defines a second planar surface, and
wherein the second planar surface is skewed relative to the first planar surface.

4. The assembly of claim 3, wherein the first bearing housing coupling portion face comprises one or more coupling apertures configured to receive at least one fastener to couple the bearing housing coupling portion to the bearing housing.

5. The assembly of claim 4, wherein the one or more coupling apertures comprise a plurlaity of coupling apertures each defined at the first bearing housing coupling portion face.

6. The assembly of claim 3,
wherein the first bearing housing coupling portion face and the second bearing housing coupling portion face intersect to form a triangular cross-sectional apex at an end of the bearing housing coupling portion that is opposite the frame coupling portion, and
wherein the frame coupling portion length forms the base of a triangular cross-sectional shape having the triangular cross-sectional apex.

7. The assembly of claim 2,
wherein the bearing housing coupling portion length is defined between the first bearing housing coupling portion face and the second bearing housing coupling portion face, and
wherein the bearing housing coupling portion length narrows moving in a direction away from the frame coupling portion by continuously tapering in the direction away from the frame coupling portion.

8. The assembly of claim 2,
wherein the frame coupling portion comprises a first frame coupling portion face extending from the first bearing housing coupling portion face at a non-parallel orientation relative to the first bearing housing coupling portion face,
wherein the frame coupling portion comprises a second frame coupling portion face extending from the second bearing housing coupling portion face at a parallel orientation relative to the second bearing housing coupling portion face, and
wherein the frame coupling portion length extends between the first frame coupling portion face and the second frame coupling portion face.

9. The assembly of claim 8, wherein the first frame coupling portion face extends from the first bearing housing coupling portion face at angle between ninety and one hundred and eighty degrees.

10. The assembly of claim 9,
wherein the frame coupling portion comprises a first frame coupling aperture adjacent to the first frame coupling portion face, and
wherein the frame coupling portion comprises a second frame coupling aperture adjacent to the second frame coupling portion face.

11. The assembly of claim 10, wherein the first frame coupling portion face begins to project outward from the first bearing housing coupling portion face at a location aligned with the first frame coupling aperture.

12. A system of bearing housing adaptors configured to couple a bearing housing to a tubular support member, the system of bearing housing adaptors comprising:
a first bearing housing adaptor comprising:
a first frame coupling portion that is configured to couple the first bearing housing adaptor to the tubular support member, and
a first bearing housing coupling portion that is configured to couple the first bearing housing adaptor to the bearing housing; and
a second bearing housing adaptor comprising:
a second frame coupling portion that is configured to couple the second bearing housing adaptor to the tubular support member, and
a second bearing housing coupling portion that is configured to couple the second bearing housing adaptor to the bearing housing.

13. The system of claim 12,
wherein the first frame coupling portion comprises a first frame coupling portion length extending along the first frame coupling portion where the first frame coupling portion is configured to interface with and couple to the tubular support member,
wherein the first bearing housing coupling portion comprises a first bearing housing coupling portion length in a direction parallel to the first frame coupling portion length, the first bearing housing coupling portion length being less than the first frame coupling portion length, and the first bearing housing coupling portion length narrowing in a direction away from the first frame coupling portion,
wherein the second frame coupling portion comprises a second frame coupling portion length extending along the second frame coupling portion where the second frame coupling portion is configured to interface with and couple to the tubular support member,
wherein the second bearing housing coupling portion comprises a second bearing housing coupling portion length in a direction parallel to the second frame coupling portion length, the second bearing housing coupling portion length being less than the second frame coupling portion length, and the second bearing housing coupling portion length narrowing in a direction away from the second frame coupling portion,
wherein the first bearing housing coupling portion is configured to couple the first bearing housing adaptor to a first side of the bearing housing, and
wherein the second bearing housing coupling portion is configured to couple the second bearing housing adaptor to a second, opposite side of the bearing housing.

14. The system of claim 13,
wherein the first frame coupling portion comprises a first frame coupling aperture,
wherein the second frame coupling portion comprises a second frame coupling aperture,
wherein the tubular support member comprises a solar tracker A-frame support, and
wherein the first frame coupling aperture of the first frame coupling portion is configured to overlap with the second frame coupling aperture of the second frame coupling portion at the solar tracker A-frame support such that a fastener can be received through each of the first frame coupling aperture of the first frame coupling portion and the second frame coupling aperture of the second frame coupling portion at the A-frame support.

15. The system of claim 12,
wherein the first bearing housing adaptor is geometrically identical to the second bearing housing adaptor.

16. The system of claim 12,
wherein the first bearing housing coupling portion is a first right angle bearing housing coupling portion comprising a cross-sectional geometry that includes a right angle adjacent to the first frame coupling portion, and
wherein the second bearing housing coupling portion is a second right angle bearing housing coupling portion comprising a cross-sectional geometry that include a right angle adjacent to the second frame coupling portion.

17. A bearing housing adaptor configured to couple a bearing housing to a tubular support member, the bearing housing adaptor comprising:
a frame coupling portion that is configured to couple the bearing housing adaptor to the tubular support member, and
an bearing housing coupling portion that is configured to couple the bearing housing adaptor to the bearing housing,
wherein the bearing housing coupling portion is a right angle bearing housing coupling portion comprising a cross-sectional geometry that includes a right angle adjacent to the first frame coupling portion.

18. The adaptor of claim 17,
wherein the bearing housing coupling portion comprises a first bearing housing coupling portion face configured to interface with the bearing housing,
wherein the bearing housing coupling portion comprises a second bearing housing coupling portion face that is opposite the first bearing housing coupling portion face,
wherein the first bearing housing coupling portion face is oriented non-parallel to the second bearing housing coupling portion face,
wherein the first bearing housing coupling portion face defines a first planar surface,
wherein the first bearing housing coupling portion comprises a plurality of coupling apertures each defined at the first planar surface of the first bearing housing coupling portion face,
wherein the second bearing housing coupling portion face defines a second planar surface, and
wherein the second planar surface is skewed relative to the first planar surface.

19. The adaptor of claim 17,
wherein the frame coupling portion comprises a frame coupling portion length extending along the frame coupling portion where the frame coupling portion is configured to interface with and couple to the tubular support member,
wherein the bearing housing coupling portion comprises a bearing housing coupling portion length in a direction parallel to the frame coupling portion length, the bearing housing coupling portion length being less than the frame coupling portion length, and the bearing housing coupling portion length narrowing in a direction away from the frame coupling portion,
wherein the frame coupling portion comprises a first frame coupling portion face extending from the first bearing housing coupling portion face at a non-parallel orientation relative to the first bearing housing coupling portion face,
wherein the frame coupling portion comprises a second frame coupling portion face extending from the second bearing housing coupling portion face at a parallel orientation relative to the second bearing housing coupling portion face, and
wherein the frame coupling portion length extends between the first frame coupling portion face and the second frame coupling portion face.

20. The adaptor of claim 19,
wherein the first frame coupling portion face extends from the first bearing housing coupling portion face at angle between ninety and one hundred and eighty degrees,
wherein the frame coupling portion comprises a first frame coupling aperture adjacent to the first frame coupling portion face, and
wherein the frame coupling portion comprises a second frame coupling aperture adjacent to the second frame coupling portion face.
